(19) United States
(12) Patent Application Publication
(10) Pub. No.: US 2011/0025925 A1
(43) Pub. Date: Feb. 3, 2011

(54) SIMPLE-TO-USE OPTICAL WIRELESS REMOTE CONTROL

(76) Inventor: Karl Christopher Hansen, Amherst, NH (US)

Correspondence Address: BROOKS KUSHMAN P.C., 1000 TOWN CENTER, TWENTY-SECOND FLOOR, SOUTHFIELD, MI, 48075, US

(21) Appl. No.: 12/937,080

(22) PCT Filed: Apr. 9, 2009
(86) PCT No.: PCT/US09/40009

§ 371 Date: Oct. 8, 2010

Related U.S. Application Data
(60) Provisional application No. 61/043,750, filed on Apr. 10, 2008.

(51) Int. Cl. H04N 5/44

(52) U.S. Cl. 348/734; 348/E05.096

(57) ABSTRACT

A system and method for controlling operation of a video display device include a wireless remote control having at least one image sensor for detecting at least one marker generally fixed relative to a video display, determining projected position of a cursor relative to the marker, and generating a command for the video display device based on position of the cursor.

### BACKGROUND

1. Technical Field

The present disclosure relates to systems and methods for remotely controlling a video display.

2. Background

The reduction in price and form factor of digital image sensors has made possible the introduction of digital imaging and/or processing into a variety of processes where it was cost- and/or performance-prohibitive to do so. Examples include optical mouse devices, “throw-away” or similar single-use digital cameras, and presentation systems such as those disclosed in U.S. Pat. Nos. 7,091,949; 6,952,198; and 6,275,214, the disclosures of which are incorporated herein by reference in their entirety. These patents disclose systems and methods that track the location of one or more pointers.

Recently this technology has been introduced into the Wii™ remote (manufactured by Nintendo Corp.) with moderate success. The approach used with the Wii™ remote, however, has significant positional restrictions for proper performance, is limited in its spatial accuracy, and fails quickly when used around candles, incandescent lights, or other point-like infrared heat sources.

### SUMMARY

Systems and methods for controlling operation of a video display device having a display controller and a display with at least one marker fixed relative to the display include detecting an image formed on an image sensor disposed within a hand-held remote control of the at least one marker and at least a portion of the display, determining projected position of a cursor associated with the hand-held remote control relative to the at least one marker and the at least a portion of the display, and wirelessly transmitting a command from the remote control for the video display controller based on at least the position of the cursor.

In one embodiment, a hand-held remote control for remotely controlling a video display having at least one marker associated therewith includes at least one image sensor, at least one emitter, and a processor in communication with the at least one image sensor and the at least one emitter. The processor processes an image of the at least one marker formed on the at least one image sensor to determine position of a pointer relative to the image of the at least one marker and generates a signal to wirelessly transmit a command to control the video display based on at least the determined position of the pointer.

In one embodiment, an optical remote control device is used to control video devices with associated displays providing output from one or more computers, game devices, or other video output devices. Embodiments include one or more markers, which may be implemented by retro-reflectors, active emitters and/or a combination thereof, mounted spatially with respect to the one or more display(s). Markers need not all be identical shapes, i.e. some may be points, some may be shapes, and some may be clusters of points/shapes that may be arranged in various patterns. Active emitters or the light source illuminating the retro-reflectors may be modulated by the system to facilitate distinguishing them from potential spoof devices or markers.

Other embodiments include a hand-held remote device with one or more image sensors and one or more light emitters. For embodiments with multiple image sensors, the sensors may be arranged with or without sensor-to-sensor image overlap. Embodiments having more than one light emitter may include a “flood-light” style emitter having a larger cone angle or divergence in addition to one or more generally collimated light emitters, such as a laser-style pointer. One or more of the emitters may be configured as an enhanced optical pointer as described in U.S. Pat. No. 6,952,192, the disclosure of which is hereby incorporated by reference in its entirety. One or more emitters may emit visible light and/or light that is outside of the visible spectrum. Embodiments may also include emitters that may or may not have features (e.g. intensity, color, shape, ‘blink’ pattern) controlled by buttons, processors, or other mechanisms in the remote control device.

The present invention provides various advantages. For example, embodiments of the present invention provide a significantly enhanced optical remote control device capable of substantially finer spatial resolution and accuracy for determination of orientation and position of the remote control. Embodiments of the present invention may be used as a universal hand-held remote control device for various types of video display systems, including televisions, computers, and projection displays, for example. For embodiments using retro-reflector markers, no separate power source is required and reflectors cannot “burn out”. Embodiments using modulated active markers or which modulate the light illuminating reflective markers enable distinguishing markers from environmental clutter and/or spoof devices. Embodiments which implement both retro-reflectors and marker modulation have the unique feature that multiple remotes can be used simultaneously with different modulations and each remote will see only its own modulation in the markers. Embodiments having emitter(s) configured as pointer(s), allow precise display locations on the video display to be determined and mapped to mouse coordinates, enabling substantially more complex computer/game interaction. Embodiments of the present invention provide a remote that becomes simple and easy to use, with the operator guided by menu items on the video display rather than having to memorize often cryptic buttons or button combinations of the remote to control the system displaying the video.

The above advantages and other advantages and features will be readily apparent from the following detailed description of the preferred embodiments when taken in connection with the accompanying drawings.

### BRIEF DESCRIPTION OF THE DRAWINGS

FIG. 1 is a block diagram illustrating operation of a system or method for remotely controlling a video display with an optical pointer according to one embodiment of the present invention;

FIG. 2 is a top/side view of an image sensor plane and video displays at varying distances illustrating the relationship between accuracy and distance for a representative optical remote control according to the present invention;

FIG. 3 illustrates a representative image sensor plane and detected display image with a projected cursor from a remote emitter according to one embodiment of the present invention;

FIG. 4 is a diagram illustrating non-collinear display markers for detecting a video display using an image sensor in a remote control device according to one embodiment of the present invention;

FIG. 5 is a diagram illustrating operation of a remote control device with an array of video display devices according to one embodiment of the present invention; and

FIG. 6 is a block diagram illustrating operation of a remote control device according to one embodiment of the present invention.

### DETAILED DESCRIPTION OF EMBODIMENT(S)

As those of ordinary skill in the art will understand, various features of the embodiments illustrated and described with reference to any one of the Figures may be combined with features illustrated in one or more other Figures to produce alternative embodiments that are not explicitly illustrated or described. The combinations of features illustrated provide representative embodiments for typical applications. However, various combinations and modifications of the features consistent with the teachings of the present disclosure may be desired for particular applications or implementations. The representative embodiments used in the illustrations relate generally to an optical remote control device for use with a video display. Those of ordinary skill in the art may recognize similar applications or implementations with other devices.

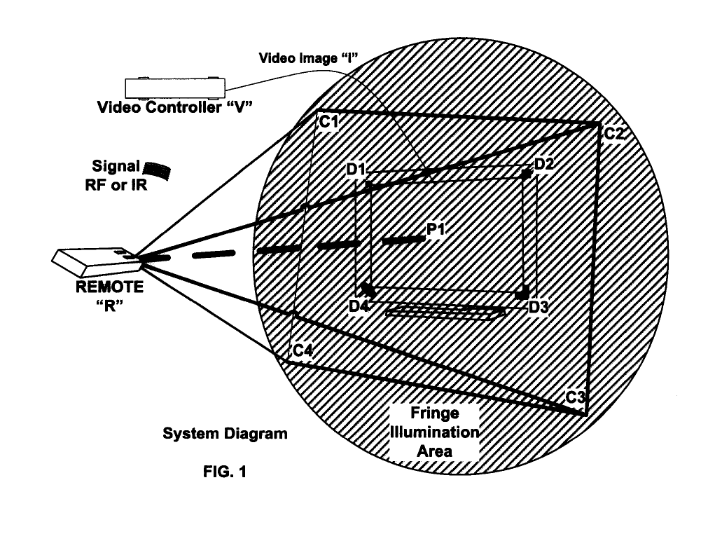

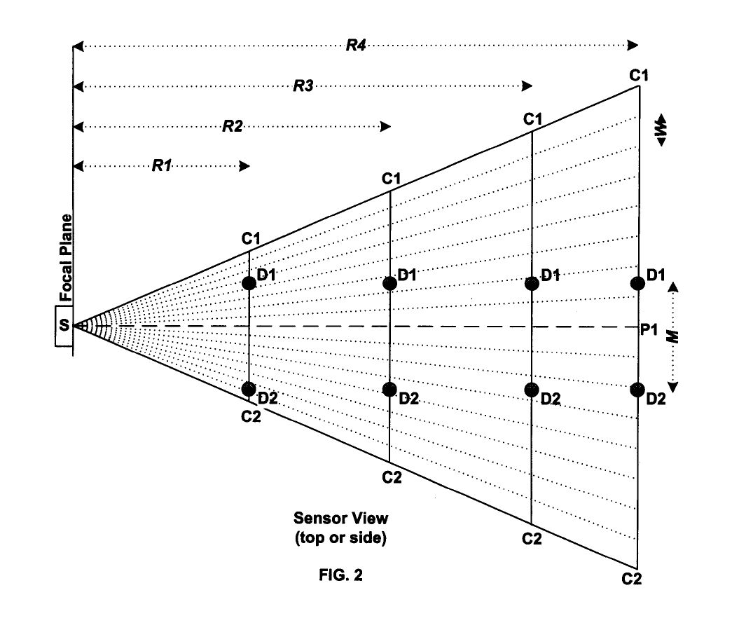

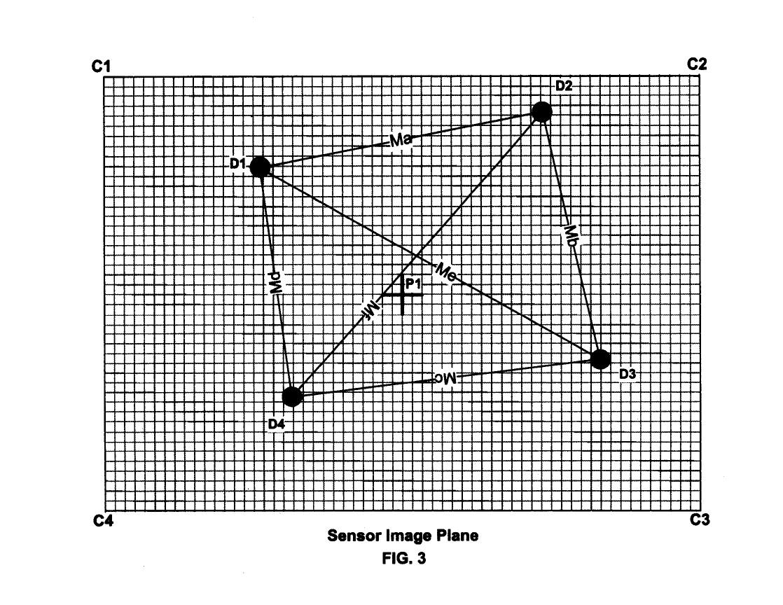

FIG. 1 shows a representative embodiment of an optical remote control for a video display according to the present invention. When the remote “R” is pointed in the general direction of any of the markers D1 . . . D4, one or more emitters within remote “R” projects light in a cone toward the video display system controlled by video controller “V”. Some of the light is reflected by one or more of the markers D1-D4 and is detected spatially by one or more of the image sensors “S” contained in remote “R”, when said markers are within the video field delimited by C1 . . . C4. In FIG. 1, the example markers D1-D4 are all within the video field. However, the remote may function with one or more of the markers outside of the sensed video image “I” as described in greater detail herein. Various applications and implementations may also use a different number of markers and/or markers of different shapes consistent with the teachings of the present invention. The system can operate with markers which are active emitters and/or markers that are retro-reflectors. One preferred mode of operation uses holographic retro-reflectors. See also D1 & D2 in FIG. 2, and D1 . . . D4 in FIG. 3. The remote communicates with a video controller “V” of one or more video devices using a wireless communication method, whether radio frequency (RF), infra-red (IR), or the method disclosed in the U.S. patents referenced and incorporated herein. The remote translates the current and/or historical calculated orientations of “R” and the relative positions of P1 with respect to markers into coordinates and/or commands and transmits them, together with remote button and/or switch states to controller. The controller modifies (as appropriate for the application and received remote data) the displayed video stream to show menus, buttons, knobs, windows, and/or other operator interface/action areas by any of several commonly known methods of updating live video, e.g. via overlays, by merging data into the video stream, or by ‘stenciling’, for example. Coordinates and/or commands received from the remote are used to interact with the system just as with commonly used Window-Icon-Mouse-Pointer (WIMP) interfaces. Those of ordinary skill in the art will recognize that video controller “V” may be a discrete component, such as a set-top box for cable television, an audio/video receiver, a video game console, etc. that provides a video signal to the video display. Alternatively, the video controller may be integrated into the video display device, such as a television, for example. Similarly, the video display may be any type of display screen such as an LCD, CRT, plasma, or other front or rear projection display.

FIG. 2 shows how distance or radius (R1, R2, R3, R4) from an imaging sensor S within the remote affects the pixel imaging of markers (D1 & D2 in the this figure). “W” represents the projected spatial width or height of a single pixel at a given radius. As is commonly known, this projected spatial width increases as distance from the sensor “S” increases. Because the physical distance between markers D1 & D2 remains fixed at “M”, the sensed or apparent spacing of D1 & D2 decreases as R increases. The apparent size of D1 & D2 also decreases. Note that at R1 both markers cover more than a single pixel. At R4 each marker is substantially less than a pixel. It should be appreciated that the relative marker/pixel size is illustrative only and not intended to stipulate any dimensional constraints. FIG. 2 generally illustrates how the ability to accurately estimate distance decreases as radius increases.

FIG. 3 represents an imaging sensor, such as a CCD, having an array of pixels. FIG. 3 illustrates how the number of markers impacts the number of measurements that can be performed when determining the spatial relation between the display and the remote. With a single marker within the sensor image plane, the number of pixels covered by a particular marker may be used to determine the distance between the display and the remote using a known size of the marker as generally illustrated and described with respect to FIG. 2. However, no additional measurements can be made to improve the accuracy of the distance determination. With two markers (D1 & D2) detected within the image plane of the sensor, the fixed measurement Ma can be made to help improve accuracy. With three markers (D1, D2, D3), there are three measurements (Ma, Mb & Me) available to more accurately determine the distance. In general, each additional fixed marker adds to the available measurements and increases the potential accuracy for determination of the position of a projected cursor relative to the markers and determination of the distance of the remote from the display, for example.

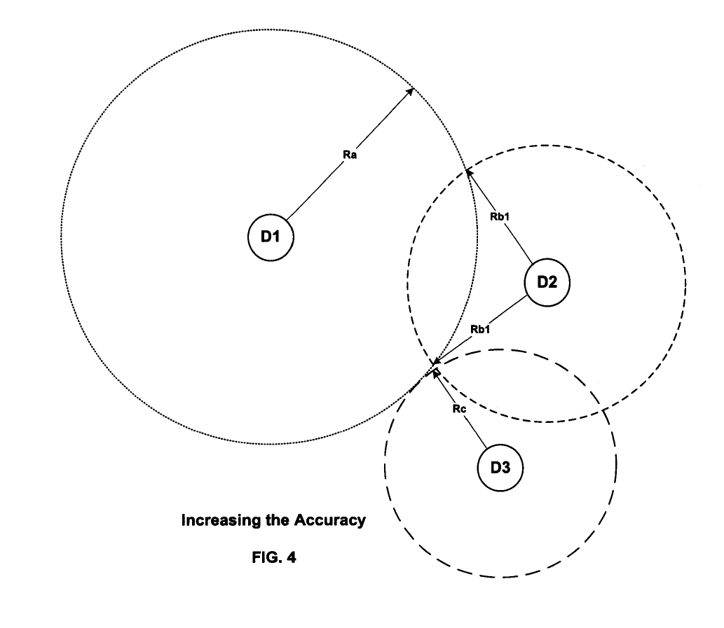

FIG. 4 shows how three or more circular non-collinear markers may be used to improve the ability to accurately determine the position and orientation of the pointer. With a single marker D1, a distance of Ra between the marker and the pointer/cursor gives a full circle of possible orientations of the remote and the pointer with respect to D1. With two markers D1 & D2, there are only two potential orientations based on the detected pointer location, shown by Rb1 and Rb2. When a third non-collinear marker is added, the number of potential orientations drops to one, shown by Rc. Note that even though the three circles may not all intersect at a single point, the three come very close to intersecting, forming a “probable location site” or position of the pointer/cursor. This is very similar to the circular error probability and/or spherical error probability calculations performed by GPS systems in wide use today.

When non-circular markers (e.g. D3 in FIG. 1) and/or a pointer having rotational asymmetry about at least one axis are used, orientation can be determined with fewer markers. However, the use of more markers will still enhance the accuracy of pointer/cursor coordinate determination, because the known shapes help to bootstrap the sub-pixel coordinate accuracy for the markers and/or pointer.

Note that if the remote does not include a pointer-style emitter, a virtual pointer or cursor P1 is arbitrarily designated as one of the pixels in the imaging plane. Any pixel, group of pixels, or intersection of pixels may serve as a virtual P1. A typical choice is one of the center-most pixels, or the center-most intersection between four pixels, for example. While this approach is functional, the ability of an operator to see precisely what they are selecting on the video display is lost, and the preferred mode of operation is with a collimated or laser-style pointer emitter that projects a visible cursor from the remote control onto the video display to provide visual feedback for the user or operator to manipulate the remote control.

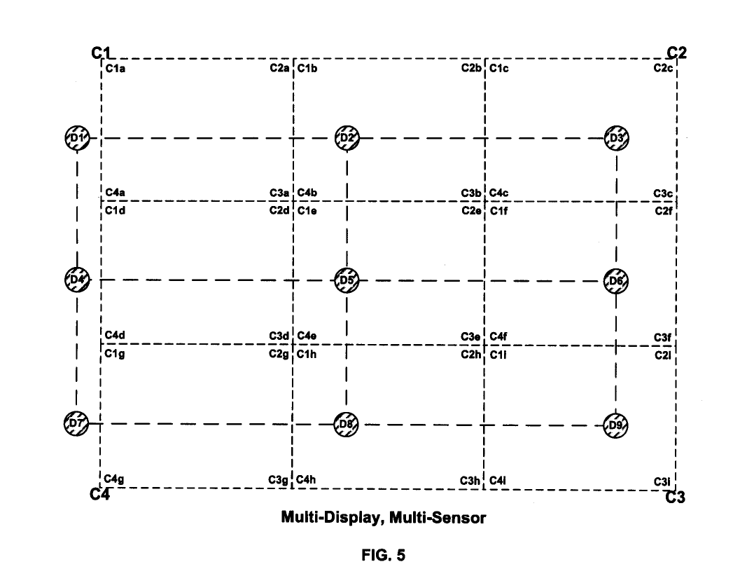

FIG. 5 shows a system with nine (9) imaging sensors within a hand-held wireless remote “R” used for controlling a paneled or tiled video display having four (4) individual 6×9 panels. In this embodiment, the display panels have markers at each “junction” and at the outermost four corners, consisting of markers D1 through D9. The sensors within the remote control each have their own coordinate system indicated by C1a . . . C4a through C1i . . . C4i, and one overall coordinate system indicated by C1 . . . C4. The system configuration (displays and sensors) is configured during assembly, calibration, or loaded from files, and thereafter can be treated as one large virtual display and one large virtual sensor. Processing of the system can be done with a single CPU or multiple CPUs operating in parallel to increase the speed of the system, depending upon the particular application and implementation.

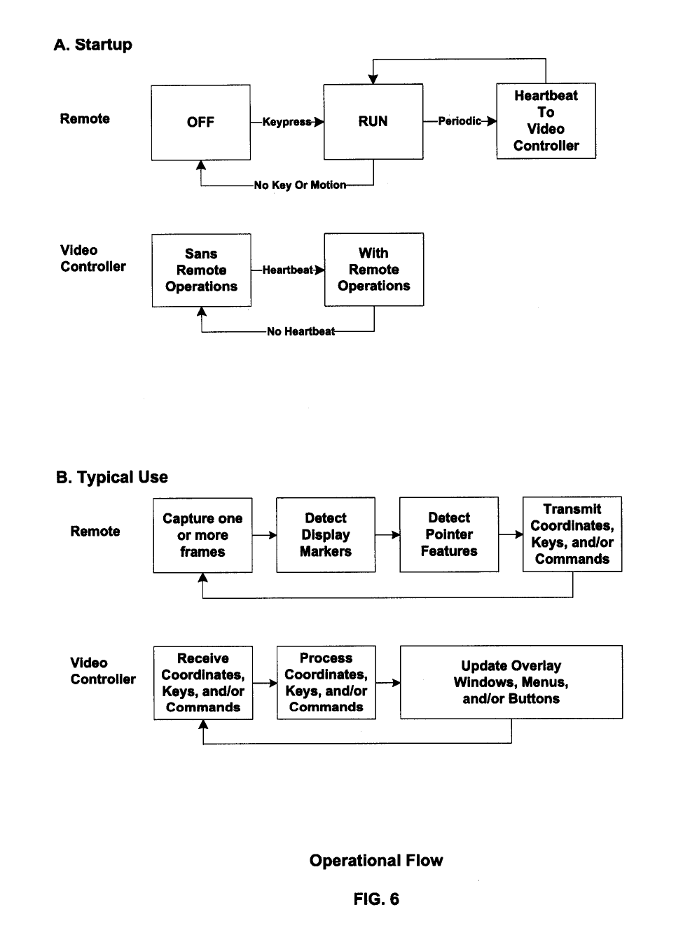

FIG. 6 shows typical flow of operations in both the remote “R” and the video controller “V”. When the remote is “OFF”, the video controller “V” runs in a no-remote mode that does not overlay active areas on the video stream. When the remote is activated, it begins transmitting periodic heartbeats to the video controller so the video controller knows to stay in the with-remote operations mode. In this mode, the remote repeatedly captures frames and analyzes them, transmitting the results together with any keypresses or other commands to the video controller. The video controller processes the received information updating any overlays appropriately, permitting control of the system with well-known menu/button/dialog interfaces. The appearance of the interface is completely arbitrary, controlled only by the desires and imagination of the interface designers.

When markers are retro-reflectors, the detected light from the markers is light reflected from the emitter(s) located in the hand-held remote. Note that even in a simple remote containing a single laser-pointer-style emitter, the retro-reflectors can still reflect light because of optical fringe effects that scatter light from the edges of the main beam to fill the video image area “I” or fringe illumination area shown in FIG. 1. In a more complex remote containing multiple emitters, one of the emitters can be configured as a flood-light distributing visible or invisible light (typically infrared in this case) over a broad area so that even at fairly large deflection angles the retro-reflectors will still return detectable images to the image sensor in the remote. Note that in this embodiment, the retro-reflectors can also be designed to only reflect the invisible light, so that they are only “visible to” or sensed by the remote and not seen by the operator or others viewing the display(s). A typical implementation using this approach would be IR retro-reflectors mounted around the periphery of a television screen, positioned behind an IR-transparent bezel-trim. To human eyes, there are no markers apparent, but because of the IR transparency of the bezel, the invisible light from the remote reaches and is reflected by the markers, and in turn detected by the remote sensor(s).

For embodiments that use a single marker, or embodiments where only a single marker of multiple markers is currently detected by the image sensor, distance of the remote from the display(s) can be estimated by the change (or roll-off) in detected intensity at the image sensor based on the properties of the emitter(s), and/or using the size of the detected image of the marker relative to a known actual marker size if the detected marker image spans multiple pixels. If the marker is appropriately shaped (e.g. D3, FIG. 1) the rotational orientation of the remote may also be estimated for a known marker size depending on whether the marker image on the sensor(s) illuminates substantially more than one pixel. FIG. 2 shows how the detected size of a given marker will vary with the distance of the remote from the marker. With a single marker, however, the orientation of the remote with respect to the display is generally ambiguous as shown by Ra in FIG. 4.

With dual markers, an improved distance estimate is obtained by scaling the spatial separation of the marker images in the sensor(s) by some calibration distance calculated during initial system configuration. In addition, the rotational orientation of the remote can be determined with better accuracy than with a single shaped reflector. This is represented by measurement “Ma” between D1 and D2 in FIG. 3. FIG. 2 shows how even though D1 and D2 have a fixed separation “M”, they will span varying numbers of pixels depending on the distance from the image plane of sensor “S”. The light dotted lines represent the view area spanned by a pixel as the depth of view increases from R1, to R2, to R3, to R4 distances. At distance “R1”, substantially more pixels are spanned between D1 and D2 compared to the span at “R4”, even though the physical distance between the markers is the same. If both “M” and the cone angle formed by the camera view angle are known a priori, it is straight forward to compute approximate distances from “S” to the center of the line between D1 and D2 using well known perspective and geometrical computations. However, there is still orientation ambiguity between the remote and the markers as represented by Rb1 and Rb2 in FIG. 4. Note that this is similar to the operation of the Wii™ remote control with the active light-bar from Nintendo Corp. That the Wii™ system suffers from orientation ambiguity can easily be demonstrated by the fact that the Wii™ remote can be used upside down or by pointing it at a mirror, which reverses left-right. The Wii™ system is also easily spoofed by IR sources such as candles, incandescent lights, etc., as is trivially demonstrated by pointing the Wii™ remote at two lit candles. In contrast, embodiments of the present invention can easily discriminate against such “noise” or unintended emitters using modulation of the markers or marker illumination.

With three or more non-collinear markers, orientation and position of the remote can be determined by modeling the perspective of the marker images in the sensor(s), and using the scaled distances from marker to marker as they appear in their images in the sensor(s). FIG. 3 shows that with four markers, the number of scaled distances that can be computed is 6 (Ma, Mb, Mc, Md, Me, MO. Each of these measurements, when the corresponding “M” physical spacing between the corresponding markers is known, aids in determining the precise remote orientation and 3D position relative to the markers once at least three non-collinear markers are used. FIG. 4 shows how the addition of a non-collinear marker resolves the orientation ambiguity of the remote and markers.

If one or more emitters is configured as laser-style pointers projecting a visible, generally collimated beam, which may also form a cursor pattern (such as a “+”), their light will be detected spatially relative to the marker(s) (see “P1” in FIGS. 1, 2 and 3), enabling determination of a separation angle from the marker(s) to the emitter light(s).

This enables significantly improved distance accuracy, as the distance from a given marker to a given emitter light will be a fixed portion of the “cone angle” that describes all possible orientations of the remote with respect to the given marker-emitter image position(s). Because this fixed portion is calibrated during system configuration, the ratio of the cone angle relative to the separation distance will give improved accuracy for determination of distance to the remote. The optical cursor also provides visual feedback to the operator by showing exactly where the remote is pointing.

The markers can be implemented by active devices that constantly or periodically emit a visible or invisible signal that is received by the image sensor in the remote control, or preferentially by passive holographic retro-reflector stickers that can be inexpensively mass-produced. For temporary use, they can be stickers such as those which can be applied multiple times “electro-statically”, and cleaned with water for reuse. Temporary markers would facilitate set-up and take-down of “game walls” where projectors display the game screens and the players interact with one or more game screens using custom remotes designed using this invention.

The computed screen coordinates of the pointer or cursor position P1 relative to the displayed video field (regardless of whether the video field is from a single display or multiple displays) are easily computed using techniques similar to those disclosed in the patents referenced and incorporated herein, as well as in many books on video and image processing describing mapping from one coordinate system into another coordinate system.

In a display system which meshes multiple video displays together (e.g. FIG. 5), the system could use display markers tagging where the stitch areas occur to facilitate transitioning from one video display coordinate system to another display coordinate system. For example, the markers may be used to determine coordinates of the pointer within a particular panel with that position mapped to a coordinate within the larger display.

The remote communicates with the controller of the video display system via RF, IR, or other wireless mechanisms as represented by the RF or IR signal in FIG. 1, for example. When the display system controller “V” is notified that the remote is pointing into an active area of the video display, the display system controller may overlay any arbitrary menus, buttons, or other controls which the operator then activates using standard WIMP-style manipulation, i.e. clicking, dragging, etc. Various embodiments of the present invention, however, also have the ability to generate commands via rotation about the axis formed between the remote “R” and “P1”, and by moving toward or away from the display (e.g. from W to Z or vice versa), opening up many more command/control mechanisms than a simple mouse, or a typical television remote.

For example, when pointed at a television, and a volume button pressed, the video display device controller could overlay a volume “knob” on the video display screen. The operator could then rotate their wrist clockwise or counterclockwise to “twist” the knob displayed on the video display screen to turn the volume up or down—a much more intuitive operation than clicking “up” or “down”.

Another example of new control capabilities is a television with “picture-in-picture” capabilities, where a small picture is displayed embedded within a larger picture. To switch from one picture to the other picture, the operator could point at the small picture, click a button on the remote to activate a “drag” function, and “drag” or pull the remote back away from the video display to enlarge the picture until the user lets go of the remote control button when the desired size is reached.

For reduced power consumption, the remote could be designed so that the embedded image sensor or sensors, emitter(s), and processor are only active when the operator presses a button. For example, pressing a button on the remote activates emitter(s), processor(s), and image sensor(s) and the remote begins transmitting a signal representing the button press as well as the detected state (position, shape, etc.) of any markers and the pointer. The video display controller receives the transmitted signal and, in response, updates overlays based on the button pressed and the position/pattern of motion of the pointer. When the operator releases the button, the display device performs any programmed command or command sequence that is valid for the operator action, which could be to “do nothing”. This mode of operation would substantially enhance battery life over any modes of operation where the processor(s), sensor(s), and/or emitter(s) remain in an active “on” mode until a “sleep” timeout or turn-off.

The remote can also incorporate logic to “dim” the emitter(s) when the sensor(s) detect a specular reflection as evidenced by a sudden surge in intensity of P1 and/or the marker(s). This can happen when the display device has a “shiny” or glossy surface, such as a flat panel or CRT-type display. On these displays, the emitter beam may be reflected back at the operator. The reflection is most intense when it is reflecting directly back towards the operator, so the remote could modulate the intensity of the emitter(s) when this is detected, reducing the chance of eye dazzle or other disorientation of the operator.

The remote can also incorporate “intelligent pointer” features where one or more pointer features are modified, making it possible to have multiple operators at the same time on the same video display field as described in the patents previously identified and incorporated by reference herein. In this situation, the different remotes would each have a unique intelligent pointer, so each remote would only track and follow its own pointer, and the set of remotes would need to use one of the many methods available for transmitting multiple signals within the same band-area, such as TDMA, FM, frequency hopping, CDMA, etc., all of which can be applied to both RF and IR transmissions.

Embedded processors within remote R may use video processing algorithms to determine with sub-pixel accuracy the image-plane coordinates of each marker and the pointer. The determined orientation of the markers may then be used to refine the accuracy of the marker locations, followed in turn by the pointer location.

In summary, adding additional markers improves the ability to compute precise coordinates for each marker, and in turn improves the accuracy of the position calculations for the pointer. This additional accuracy permits a video controller to use a substantially enhanced user interface for controlling the system. The combination permits substantial simplification of the remote controller while increasing the ability to control the system.

In operation, a representative embodiment of a system or method is implemented by a hand-held remote that communicates with a video display controller which operates a television or similar device. When the remote detects the pointer and display markers, it transmits coordinates and orientation information to the video controller. The video controller overlays appropriate buttons and menus to facilitate channel selection, volume change, picture-in-picture selection, control of additional devices such as stereos, lights, etc., in appropriate areas of the display. As is commonly known, these overlays can be made translucent to permit continued viewing of the video stream while still controlling the system. Similarly, the a remote control according to the present invention may be used to operate other graphical user interfaces displayed on the display screen, such as those associated with a video game, computer software applications, internet browsing, and television set-top box operation, for example. The menu system or other user interface may be as simple or as complex as desired.

If visible light is used for one or more of the emitters, the user can see which item in the active display will be selected by an action such as a remote button ‘click’.

As such, the present invention provides a significantly enhanced optical remote control device capable of substantially finer spatial resolution and accuracy for determination of orientation and position of the remote control. Embodiments of the present invention may be used as a universal hand-held remote control device for various types of video display systems, including televisions, computers, and projection displays, for example. The present invention provides a remote that becomes simple and easy to use, with the operator guided by menu items on the video display rather than having to memorize often cryptic buttons or button combinations of the remote to control the system displaying the video.

While the best mode has been described in detail, those familiar with the art will recognize various alternative designs and embodiments within the scope of the following claims. While various embodiments may have been described as providing advantages or being preferred over other embodiments with respect to one or more desired characteristics, as one skilled in the art is aware, one or more characteristics may be compromised to achieve desired system attributes, which depend on the specific application and implementation. These attributes include, but are not limited to: cost, strength, durability, life cycle cost, marketability, appearance, packaging, size, serviceability, weight, manufacturability, ease of assembly, etc. The embodiments discussed herein that are described as less desirable than other embodiments or prior art implementations with respect to one or more characteristics are not outside the scope of the disclosure and may be desirable for particular applications.

What is claimed:

1. A method for controlling operation of a system having at least a video display controller and a display with at least one marker fixed relative to the display, the method comprising:
detecting an image formed on an image sensor disposed within a hand-held remote control of the at least one marker and at least a portion of the display;
determining projected position of a cursor associated with the hand-held remote control relative to the at least one marker and the at least a portion of the display; and
wirelessly transmitting a command from the remote control for the video display controller based on at least the position of the cursor.

2. The method of claim 1 further comprising illuminating the at least one marker with light projected from the hand-held remote control.

3. The method of claim 2 wherein illuminating comprises illuminating the at least one marker with invisible light.

4. The method of claim 1 wherein the at least one marker comprises an asymmetrically shaped retro-reflector positioned on the display.

5. The method of claim 1 further comprising projecting the cursor using visible light onto the display.

6. The method of claim 5 further comprising decreasing intensity of the projected cursor in response to an increase in intensity of a cursor image formed on the image sensor.

7. The method of claim 1 wherein the cursor comprises a virtual cursor associated with the intersection of an imaginary line extending between at least one pixel of the image sensor of the remote control and the display.

8. The method of claim 1 wherein determining position comprises determining distance of the hand-held remote control from the display.

9. The method of claim 8 wherein the distance is determined based on a change of intensity of the image formed on the image sensor.

10. The method of claim 8 wherein the distance is determined based on size of the image of the at least one marker formed on the image sensor.

11. The method of claim 8 wherein wirelessly transmitting a command comprises wirelessly transmitting a command based on the distance of the remote from the display.

12. The method of claim 1 wherein the at least one marker includes at least three non-collinear markers and wherein determining projected position comprises:
determining scaled distances between the at least three markers from the image formed on the image sensor; and
determining the projected position based on a relationship between the scaled distances from the image and corresponding actual distances between the at least three markers.

13. The method of claim 1 further comprising deactivating the remote after wirelessly transmitting a command until a subsequent button press.

14. A hand-held remote control for remotely controlling a system with at least one video display having at least one marker associated therewith, the remote control comprising:
at least one image sensor;
at least one emitter; and
a processor in communication with the at least one image sensor and the at least one emitter, the processor processing an image of the at least one marker formed on the at least one image sensor to determine position of a pointer relative to the image of the at least one marker and generating a signal to wirelessly transmit a command to control the video display based on at least the determined position of the pointer.

15. The hand-held remote control of claim 14 wherein the pointer is a virtual pointer represented by at least one designated pixel of the image sensor.

16. The hand-held remote control of claim 14 wherein the image sensor comprises at least one pixel array.

17. The hand-held remote control of claim 14 wherein the emitter comprises an infrared emitter.

18. The hand-held remote control of claim 14 further comprising a laser pointer.

19. The hand-held remote control of claim 18 wherein the processor reduces intensity of the laser pointer in response to detecting an increase in intensity of an image of the pointer formed on the image sensor.

20. The hand-held remote control of claim 14 wherein the processor determines distance of the hand-held remote control from the video display based on scaled distances between images of at least three non-collinear markers.
